(19) United States
(12) Patent Application Publication
(10) Pub. No.: US 2013/0003004 A1
(43) Pub. Date: Jan. 3, 2013

(54) LIQUID CRYSTAL PANEL AND LIQUID CRYSTAL DISPLAY DEVICE

(76) Inventors: Masahiro Shimizu, Osaka-shi (JP); Ken Kuboki, Osaka-shi (JP); Hiroyuki Ohgami, Osaka-shi (JP); Yoshito Hashimoto, Osaka-shi (JP); Yuichi Iyama, Osaka-shi (JP); Yusuke Nishihara, Osaka-shi (JP)

(21) Appl. No.: 13/574,061

(22) PCT Filed: Nov. 9, 2010
(86) PCT No.: PCT/JP2010/069938

§ 371 Date: Aug. 22, 2012

(30) Foreign Application Priority Data
Jan. 22, 2010 (JP) 2010-012483

(51) Int. Cl. G02F 1/1337

(52) U.S. Cl. 349/130

(57) ABSTRACT

A liquid crystal panel includes (i) an active matrix substrate (10) on which pixel electrodes (12) are provided for respective pixels (8), (ii) a counter substrate (20) on which a common electrode is provided and which faces the active matrix substrate (10), (iii) a liquid crystal layer which is provided between the active and counter substrates (10, 20) and has a negative dielectric anisotropy, and (iv) two vertical alignment films (14, 24) provided over respective of the active and counter substrates (10, 20). The pixel electrode (12) has subpixel electrodes (12a, 12b) and connection electrodes (15) for connecting the subpixel electrodes (12a, 12b). Each of the subpixel electrodes (12a, 12b) has branch line parts (18) and a trunk line part (17) demarcated by slits (16). In the pixel (8), the subpixel electrodes (12a, 12b) are connected with each other via the connection electrodes (15) in a plurality of locations.

### TECHNICAL FIELD

The present invention relates to (i) a vertical alignment type liquid crystal panel in which liquid crystal molecules are oriented in a substantially vertical direction with respect to a main surface of a substrate while no voltage is applied and (ii) a liquid crystal display device.

### BACKGROUND ART

A liquid crystal display device is thin and lightweight and consumes little electricity, as compared to other various display devices. Under the circumstances, liquid crystal display devices are widely used in various fields such as television devices, monitors, and mobile phones.

Various display methods of a liquid crystal display device are known, and one of such various display methods is called a VA (Vertical Alignment) mode in which liquid crystal molecules are aligned substantially perpendicular to a substrate surface while no electric field is applied.

According to the VA mode, a normally black display is carried out with the use of (i) a vertical alignment type liquid crystal layer containing a nematic liquid crystal material which achieves high contrast due to vertical alignment and has a negative dielectric anisotropy and (ii) a pair of polarization plates arranged in a crossed Nicols arrangement. With the features, the VA mode can achieve high black display quality.

According to a vertical alignment type liquid crystal display device employing a vertical alignment mode such as the VA mode, transmittance is changed by rotating liquid crystal molecules from a direction perpendicular to a substrate surface to a direction in parallel with the substrate surface, by applying a vertical electric field, which is perpendicular to the substrate surface, to the liquid crystal molecules.

It is generally known that, in such a vertical alignment mode, a viewing angle is improved by controlling liquid crystal molecules to be tilted, when a voltage is applied, in a plurality of directions such that a multi-domain configuration is provided, that is, a plurality of areas (domains) including bright and dark areas are provided in one (1) pixel.

With regard to a so-called MVA (Multi-domain Vertical Alignment) mode liquid crystal display device having such a multi-domain configuration, a method, in which fine slits are provided in a pixel electrode so that the pixel electrode has a fish-bone structure, is known as one of alignment controlling means (domain controlling means) for controlling azimuths in which liquid crystal molecules are tilted while an electric field is applied (e.g., see Patent Literature 1).

FIG. 13 is a plane view illustrating a schematic configuration of one (1) pixel of a liquid crystal display device disclosed in Patent Literature 1.

In the example illustrated in FIG. 13, one (1) pixel 8 is divided into subpixels 8a and 8b along a signal line 6. The subpixels 8a and 8b are provided in respective upper half and lower half parts of the pixel 8 such that an auxiliary capacitor line 7, extending in parallel with a scanning line 5, is provided between the subpixels 8a and 8b.

In a pixel electrode 12 provided for the subpixels 8a and 8b (hereinafter, parts of the pixel electrode 12 corresponding to the respective subpixels 8a and 8b are referred to as “subpixel electrodes 12a and 12b”), slits 16 are minutely provided from a circumferential part of the pixel electrode 12 so that the pixel electrode 12 has a fish-bone structure. The pixel electrode 12, which has thus the fish-bone structure formed in a fish-bone-like shape by the fine slits 16, is called a fish-bone type pixel electrode.

Orientation azimuths of liquid crystal molecules in the subpixels 8a and 8b are controlled by oblique electric fields in edge parts of the subpixel electrodes 12a and 12b, which edge parts are formed by providing the slit 16 from the circumferential parts of the subpixel electrodes 12a and 12b.

Each of the subpixel electrodes 12a and 12b of such a pixel electrode 12 is mainly made up of a trunk line part 17 and branch line parts 18. In each of the subpixels 8a and 8b, a trunk line part 17 has a substantially perpendicular cross shape. The branch line parts 18 obliquely extend from each of the trunk line parts 17, i.e., at 45 degrees with respect to the trunk line parts 17.

In each of the subpixels 8a and 8b having such a configuration, four orientation areas (i.e., orientation areas R1, R2, R3, and R4), which are separated from each other by a corresponding trunk line part 17, are provided. In a case where (i) a rightward azimuth is defined as 0 degree and (ii) angles are measured in a counterclockwise direction, (i) branch line parts 18 in the orientation area R1 extend from a corresponding trunk line part 17 at 45 degrees, (ii) branch line parts 18 in the orientation area R2 extend from a corresponding trunk line part 17 at 135 degrees, (iii) branch line parts 18 in the orientation area R3 extend from a corresponding trunk line part 17 at 225 degrees, and (iv) branch line parts 18 in the orientation area R4 extend from a corresponding trunk line part 17 at 315 degrees. In each of the orientation areas R1 through R4, a plurality of branch line parts 18 are provided so as to extend, from the trunk line part 17, in parallel with each other.

The trunk line parts 17 of the respective subpixels 8a and 8b are connected with each other via a connection electrode 15 formed in parallel with the signal line 6.

### CITATION LIST

### Patent Literature

### [Patent Literature 1]

Japanese Patent Application Publication Tokukai No. 2007-249243 A (Publication date: Sep. 27, 2007)

### SUMMARY OF INVENTION

### Technical Problem

According to a liquid crystal display device employing such a fish-bone type pixel electrode, it is possible to provide a bright area and a dark area with a single voltage applied to the pixel electrode, by changing (i) area sizes of the respective subpixels 8a and 8b and (ii) pitches at which the slits 16 are provided in each of the subpixels 8a and 8b.

Note, however, that it is necessary to connect the subpixel electrodes 12a and 12b (of the respective adjacent subpixels 8a and 8b) with each other, as illustrated in FIG. 13.

However, in a case where the subpixel electrodes 12a and 12b are connected with each other via the connection electrode 15 in one (1) location (see FIG. 13), display quality is sometimes decreased.

This is because, if the connection electrode 15 dotted in FIG. 13 is broken when the pixel electrode 12 is formed, a defective pixel is produced to which a voltage cannot be applied.

The present invention is accomplished in view of the problem, and its object is to provide a liquid crystal panel and a liquid crystal display device which can suppress (i) occurrence of a defective pixel and (ii) a decrease in display quality.

### Solution to Problem

In order to attain the object, a liquid crystal panel of the present invention includes: a first substrate on which pixel electrodes are provided for respective pixels; a second substrate on which a common electrode is provided, the second substrate being provided so as to face the first substrate; a liquid crystal layer provided between the first substrate and the second substrate, the liquid crystal layer having a negative dielectric anisotropy; and a pair of vertical alignment films provided over respective of the first substrate and the second substrate, each of the pixels being divided into a plurality of subpixels, each of the pixel electrodes having (i) a plurality of subpixel electrodes and (ii) a plurality of connection electrodes via which adjacent two of the plurality of subpixel electrodes are connected with each other, each of the plurality of subpixels having a plurality of linear electrodes demarcated by a plurality of slits, in each of the pixels, any adjacent first and second subpixel electrodes of the plurality of subpixel electrodes, being connected with each other in a plurality of locations by connecting some of first linear electrodes of the first subpixel electrode with respective second linear electrodes of the second subpixel electrode via respective connection electrodes.

In a case where a conventional pixel electrode pattern is employed in which subpixel electrodes are connected with each other in one (1) location by connecting trunk electrodes of the respective subpixel electrodes with each other via a connection electrode, if the connection electrode is broken, a voltage will not be sent from one subpixel to the other subpixel, and therefore a subpixel occurs to which no voltage is to be applied. As a result, a defective pixel is caused.

On the other hand, as in the configuration of the present invention, in a case where adjacent subpixel electrodes in each pixel are connected with each other in a plurality of locations such that corresponding subpixels are connected with each other in a plurality of locations, it is possible to prevent a defective pixel even if a disconnection is caused in any of the plurality of locations, because the subpixels are connected with each other in the other locations.

According to the configuration of the present invention, it is therefore possible to provide a liquid crystal panel which can suppress a decrease in display quality.

A liquid crystal display device of the present invention includes the liquid crystal panel of the present invention. The liquid crystal display device of the present invention can therefore suppress (i) occurrence of a defective pixel and (ii) a decrease in display quality.

### Advantageous Effects of Invention

As above described, in the liquid crystal panel and the liquid crystal display device of the present invention, linear electrodes of subpixel electrodes are connected with each other via a plurality of connection electrodes such that adjacent subpixel electrodes in each pixel are connected with each other in a plurality of locations. With the configuration, it is possible to prevent a defective pixel caused by a disconnection.

According to the present invention, it is therefore possible to provide the liquid crystal panel which can suppress (i) occurrence of a defective pixel and (ii) a decrease in display quality.

### BRIEF DESCRIPTION OF DRAWINGS

FIG. 1

(a) of FIG. 1 is a plane view illustrating a schematic configuration of a pixel in a liquid crystal panel, in accordance with an embodiment of the present invention. (b) of FIG. 1 illustrates an orientated state of liquid crystal molecules, which is obtained by carrying out an orientation simulation with respect to a pixel electrode pattern illustrated in (a) of FIG. 1.

FIG. 2

FIG. 2 is a cross sectional view illustrating a schematic configuration of a main part of a liquid crystal display device, in accordance with an embodiment of the present invention.

FIG. 3

FIG. 3 is a cross sectional view illustrating an oriented state of liquid crystal molecules in a main part of a liquid crystal panel illustrated in FIG. 2, to which liquid crystal panel an electric field is being applied.

FIG. 4

(a) of FIG. 4 is a plane view illustrating an example layout of a pixel electrode pattern in one pixel of a liquid crystal panel, in accordance with an embodiment of the present invention. (b) of FIG. 4 illustrates an orientated state of liquid crystal molecules, which is obtained by carrying out an orientation simulation with respect to the pixel electrode pattern illustrated in (a) of FIG. 4.

FIG. 5

(a) of FIG. 5 is a plane view illustrating another example layout of a pixel electrode pattern in one pixel of a liquid crystal panel, in accordance with an embodiment of the present invention. (b) of FIG. 5 illustrates an orientated state of liquid crystal molecules, which is obtained by carrying out an orientation simulation with respect to the pixel electrode pattern illustrated in (a) of FIG. 5.

FIG. 6

FIG. 6 is a plane view schematically illustrating an orientation characteristic of liquid crystal molecules in edge parts of branch line parts of subpixel electrodes, which orientation characteristic is obtained while an electric field is applied.

FIG. 7

FIG. 7 is a plane view schematically illustrating an orientation characteristic of liquid crystal molecules, which is obtained while an electric field is applied, in branch line parts extended from a trunk line part of a subpixel electrode.

FIG. 8

FIG. 8 is a plane view schematically illustrating an orientation characteristic of liquid crystal molecules in a subpixel of a liquid crystal panel, in accordance with an embodiment of the present invention.

FIG. 9

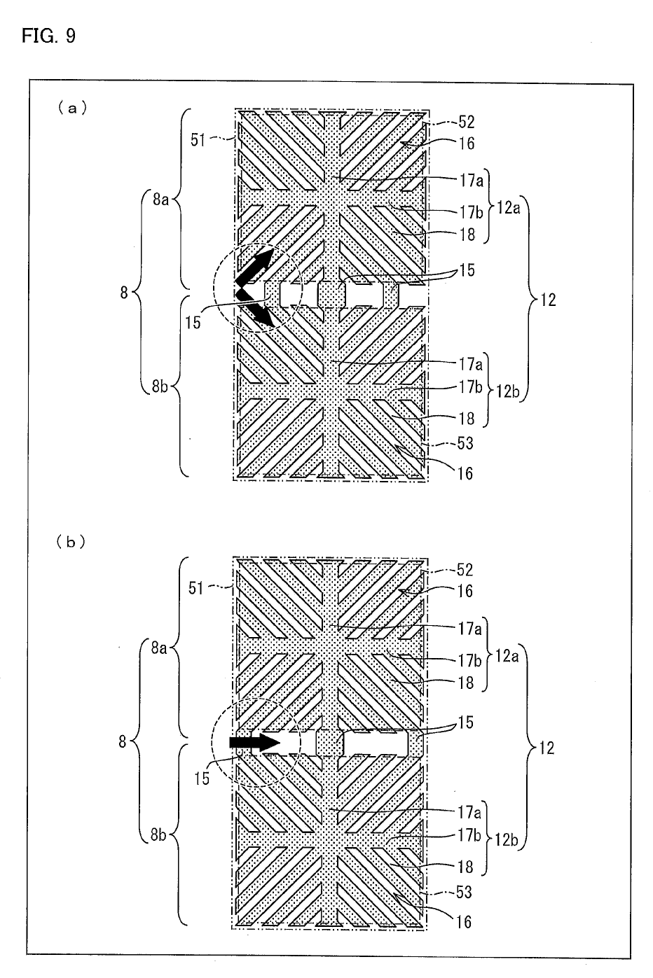

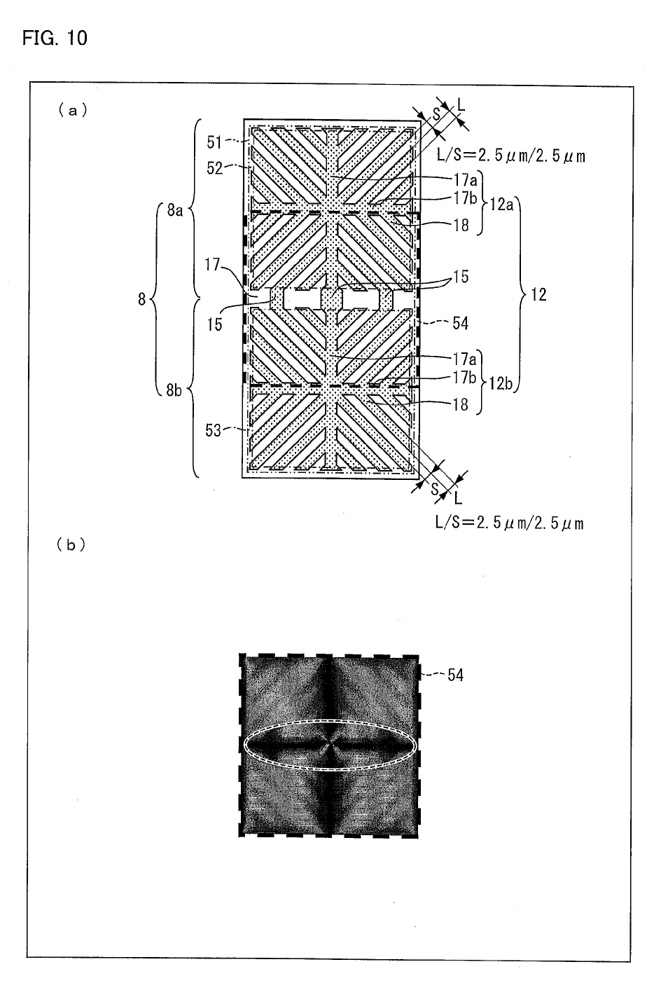

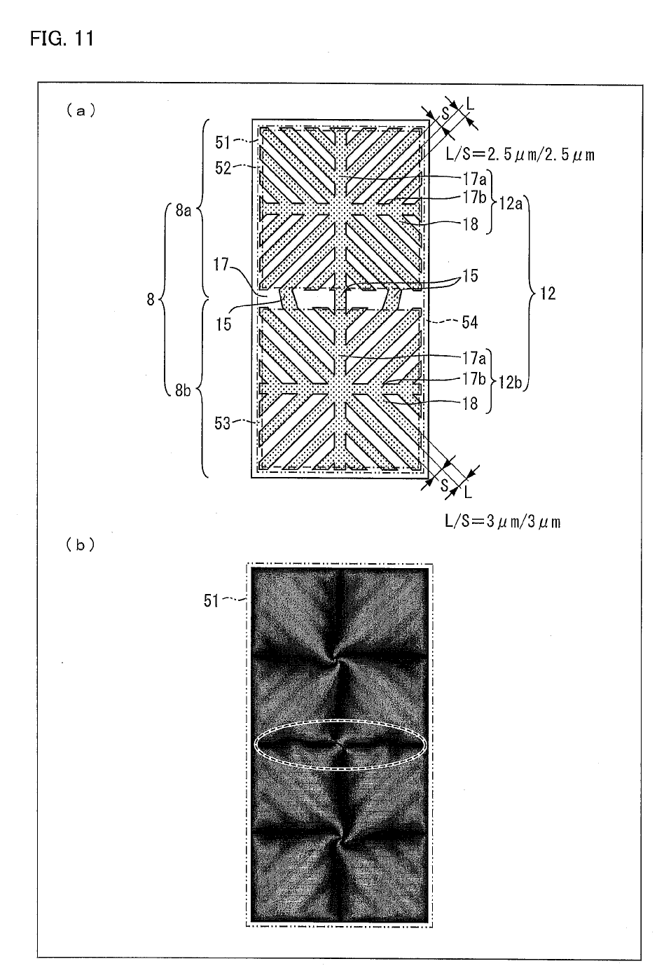

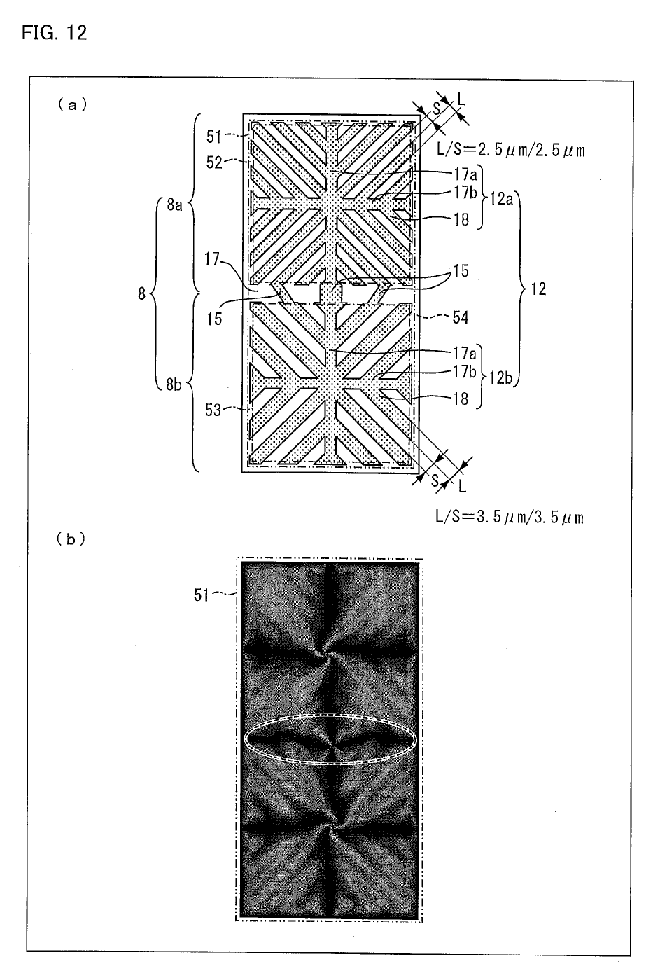

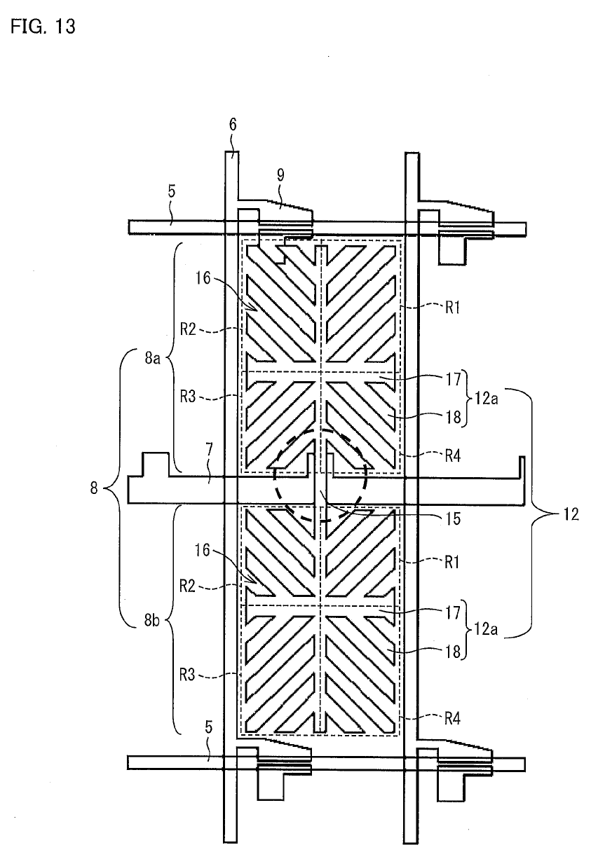

(a) of FIG. 9 is a plane view illustrating a layout of a pixel electrode pattern in a pixel in which branch line parts of a subpixel electrode, which are second ones from both right and left sides of a circumferential edge of a pixels electrode, are connected with respective branch line parts of adjacent subpixel electrode, which are also second ones from both the right and left sides of the circumferential edge. (b) of FIG. 9 is a plane view illustrating a layout of a pixel electrode pattern in a pixel in which branch line parts of respective adjacent subpixel electrodes are connected with each other in each of locations abutting on both right and left sides of a circumferential edge of a pixel electrode.

FIG. 10

(a) of FIG. 10 is a plane view illustrating an example layout of a pixel electrode pattern in which a width L and a width S in a subpixel are identical with those in an adjacent subpixel. (b) of FIG. 10 illustrates an oriented state of liquid crystal molecules obtained by carrying out an orientation simulation with respect to the pixel electrode pattern illustrated in (a) of FIG. 10.

FIG. 11

(a) of FIG. 11 is a plane view illustrating an example layout of a pixel electrode pattern in which a width L and a width S in a subpixel are different from those in an adjacent subpixel. (b) of FIG. 11 illustrates an oriented state of liquid crystal molecules obtained by carrying out an orientation simulation with respect to the pixel electrode pattern illustrated in (a) of FIG. 11.

FIG. 12

(a) of FIG. 12 is a plane view illustrating an example layout of a pixel electrode pattern in which a width L and a width S in a subpixel are different from those in an adjacent subpixel. (b) of FIG. 12 illustrates an oriented state of liquid crystal molecules obtained by carrying out an orientation simulation with respect to the pixel electrode pattern illustrated in (a) of FIG. 12.

FIG. 13

FIG. 13 is a plane view illustrating a schematic configuration of a pixel of a liquid crystal display device disclosed in Patent Literature 1.

### DESCRIPTION OF EMBODIMENTS

The following description will discuss an embodiment of the present invention in detail.

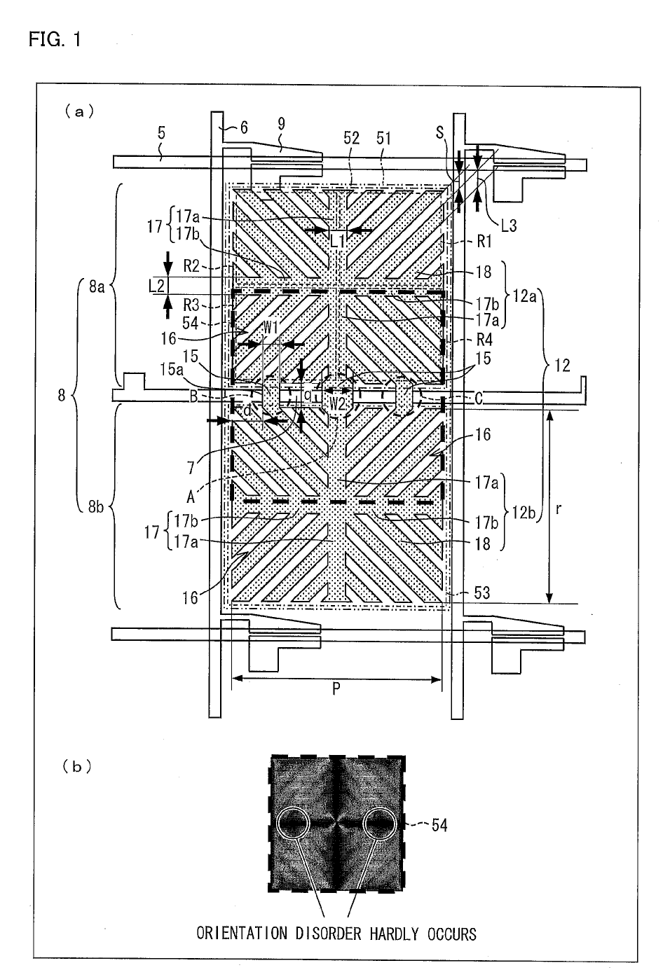

The following description will discuss an embodiment of the present invention with reference to (a) and (b) of FIG. 1 through FIG. 12.

Note that, in the present embodiment, identical reference numerals are given to constituent members having functions identical to those of the liquid crystal display device disclosed in Patent Literature 1 (see FIG. 13), and descriptions of such constituent members are omitted here.

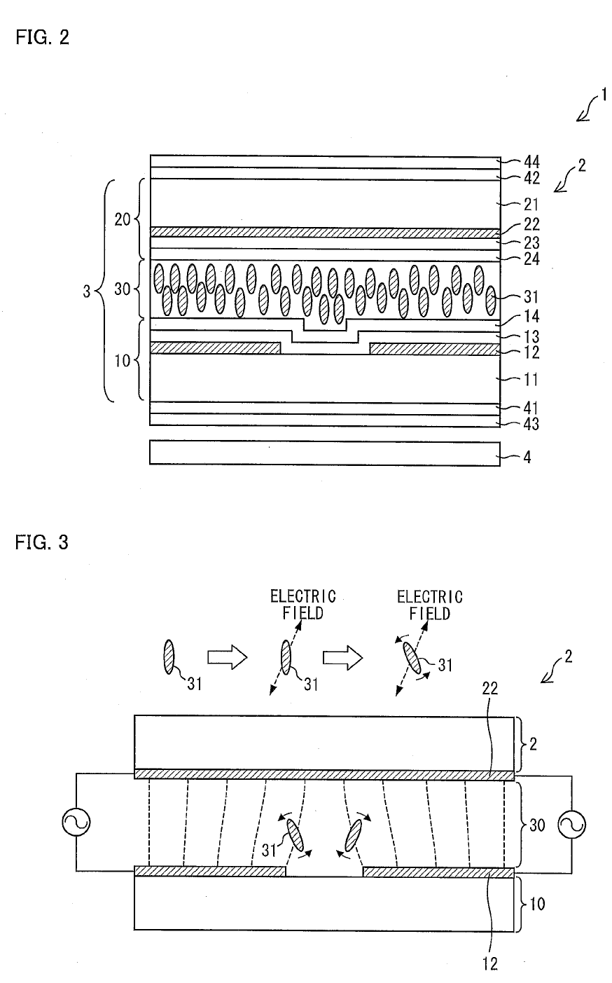

The following description will discuss, with reference to FIGS. 2 and 3, a schematic configuration of a liquid crystal display device in accordance with the present embodiment.

FIG. 2 is a cross sectional view illustrating a schematic configuration of a main part of the liquid crystal display device in accordance with the present embodiment. Note that FIG. 2 illustrates an aligned state of liquid crystal molecules obtained while no electric field is applied to the liquid crystal molecules.

FIG. 3 is a cross sectional view illustrating a state in which the liquid crystal molecules are oriented in a main part of a liquid crystal panel illustrated in FIG. 2, in which liquid crystal panel an electric field is being applied. Note that, in FIGS. 2 and 3, configurations of the liquid crystal display device and the liquid crystal panel are partially omitted.

A liquid crystal display device 1 of the present embodiment includes members such as a liquid crystal panel (liquid crystal display panel), a driving circuit (not illustrated) for driving the liquid crystal panel 2, a control circuit (not illustrated) for controlling the driving circuit, and a backlight 4 provided as appropriate (see FIG. 2).

The liquid crystal panel 2 includes (i) an active matrix substrate 10 (array substrate, first substrate) and (ii) a counter substrate 20 (second substrate) provided so as to face the active matrix substrate 10 (see FIG. 2).

The liquid crystal panel 2 of the present embodiment is a vertical alignment type liquid crystal panel in which liquid crystal molecules 31 are aligned in a direction substantially perpendicular to a substrate surface while no electric field is applied to the liquid crystal molecules 31. In the liquid crystal panel 2, a liquid crystal layer 30 is provided between the active matrix substrate 10 and the counter substrate 20. Note that the liquid crystal layer 30 serves as a display medium layer and has a negative dielectric anisotropy. In order to obtain an intended physical property, the liquid crystal layer 30 can contain various additives other than a liquid crystal material to a degree that does not adversely affect displaying of the liquid crystal panel 2.

The liquid crystal panel 2 has a liquid crystal cell 3 which is formed by (i) combining the active matrix substrate 10 and the counter substrate 20 together by a sealing agent via spacers (not illustrated) and (ii) filling, with a medium, a space between the active matrix substrate 10 and the counter substrate 20. The medium contains a liquid crystal material having a negative dielectric anisotropy.

The active matrix substrate 10 is configured so that pixel electrodes 12 are provided, on an insulating substrate 11, for respective pixels. Note that the insulating substrate 11 is made of a material such as glass which has a light-transmitting property. The counter substrate 20 is configured so that a common electrode 22 is provided over an entire display area on an insulating substrate 21. Note that the insulating substrate 21 is made of a material such as glass which has a light-transmitting property.

Each of the pixel electrodes 12 and the common electrode 22 is made from a transparent conductive film such as ITO (Indium Tin Oxide) or IZO (Indium Zinc Oxide).

Vertical alignment films 13 and 23 are provided on the pixel electrodes 12 and the common electrode 22, respectively, so that the liquid crystal molecules 31 in the liquid crystal layer 30 are aligned in a direction substantially perpendicular to the substrate surface while no electric field is applied to the liquid crystal molecules 31. Each of the vertical alignment films 13 and 23 can be formed by applying a known alignment film material, such as polyimide, which controls liquid crystal molecules to be vertically aligned.

Polymer layers 14 and 24 (alignment maintaining layer) are provided in the vicinity of interfaces between respective of the vertical alignment films 13 and 23 and the liquid crystal layer 30. The polymer layers 14 and 24 control orientations of the liquid crystal molecules 31 in the liquid crystal layer 30 such that liquid crystal molecules 31 are tilted in a plurality of directions in each pixel while an electric field is being applied across the liquid crystal layer 30.

Each of the polymer layers 14 and 24 is formed by, for example, polymerizing a polymerizable material contained in the liquid crystal layer 30. The polymer layers 14 and 24 control a pre-tilt azimuth and a pre-tilt angle of each of the liquid crystal molecules 31.

Each of the polymer layers 14 and 24 is formed by use of a so-called PSA (Polymer Sustained Alignment) technique in which, after the liquid crystal cell 3 is formed, a polymerizable material (photopolymerizable component, e.g., photopolymerizable monomer), which has been mixed in a liquid crystal material in advance, is polymerized by being irradiated with an active energy ray such as an ultraviolet ray while an electric field is being applied across the liquid crystal layer 30.

While no electric field is applied (initial state), the liquid crystal molecules 31 are vertically aligned by the vertical alignment films 13 and 23 (see FIG. 2 and an upper left part with respect to the liquid crystal panel 2 shown in FIG. 3).

Then, a vertical electric field is applied across the pixel electrode 12 and the common electrode 22 (see FIG. 3). This causes an oblique electric field to be generated in an edge part of the pixel electrode 12. The oblique electric field causes the liquid crystal molecules 31 in the liquid crystal layer 30 to be oriented so that their major axes are perpendicular to the oblique electric field. This is because the liquid crystal molecules 31 have the negative dielectric anisotropy (see FIG. 3). Note that an upper part with respect to the liquid crystal panel 2 shown in FIG. 3 illustrates, from left to right, how a liquid crystal molecule 31 is oriented.

As a result, in the present embodiment, four domains are formed in which directors of the liquid crystal molecules 31 have respective azimuth angles of 45 degrees, 135 degrees, 225 degrees, and 315 degrees, when the liquid crystal layer 30 is viewed from a direction in which a normal line of the liquid crystal layer 30 extends (details will be described later).

In this state, in a case where the photopolymerizable monomer is photopolymerized by being irradiated with, for example, an active energy ray such as an ultraviolet ray, the state in which the liquid crystal molecules 31 are orientated, which state is obtained when the polymer layers 14 and 24 (see FIG. 2) are generated, is maintained (memorized), even after the electric field is removed (i.e., in a state where no electric field is applied).

As such, the pre-tilt azimuths and the pre-tilt angles of the liquid crystal molecules 31, controlled by the polymer layers 14 and 24 (i.e., tilt azimuths and tilt angles of the liquid crystal molecules 31 obtained while no electric field is applied, that is, an angle between the respective liquid crystal molecules 31 and the substrate surface), are identical with azimuths of the directors of the liquid crystal molecules 31 in the domains (later described), which azimuths of the directors of the liquid crystal molecules 31 are formed while an electric field is applied across the liquid crystal layer 30.

It is possible to adjust the pre-tilt azimuths and the pre-tilt angles of the liquid crystal molecules 31, by thus controlling a factor such as an electric field being applied to the liquid crystal layer 30 while the polymer layers 14 and 24 are being formed by the use of the PSA technique.

Note that, since the PSA technique does not require a rubbing process, the PSA technique is suitable for forming a vertical alignment type liquid crystal layer 30 in which a direction, in which the liquid crystal molecules 31 are pre-tilted, is difficult to control by such a rubbing process.

A lower quarter wave plate 41 and an upper quarter wave plate 42, which have respective optical axes perpendicular to each other, are provided on both outer sides of the liquid crystal cell 3. Specifically, the lower quarter wave plate 41 is provided on a surface of the active matrix substrate 10 which surface is opposite to the liquid crystal layer 30, and the upper quarter wave plate 42 is provided on a surface of the counter substrate 20 which surface is opposite to the liquid crystal layer 30. A lower polarization plate 43 and an upper polarization plate 44, which have respective absorption axes perpendicular to each other, are provided on outer surfaces of the respective lower and upper quarter wave plates 41 and 42. Note that (i) there is a difference of 45 degrees between the optical axis of the lower quarter wave plate 41 and the absorption axis of the lower polarization plate 43 and (ii) there is a difference of 45 degrees between the optical axis of the upper quarter wave plate 42 and the absorption axis of the upper polarization plate 44.

(a) of FIG. 1 is a plane view illustrating a schematic configuration of a pixel in the active matrix substrate 10 of the liquid crystal panel 2. (b) of FIG. 1 illustrates an orientation simulation result obtained by use of a pixel electrode pattern illustrated in (a) of FIG. 1.

The active matrix substrate 10 has a plurality of scanning lines 5 and a plurality of signal lines 6 which are provided such that the plurality of scanning lines 5 intersect with the plurality of signal lines 6 (see (a) of FIG. 1). Regions, compartmentalized by the plurality of scanning lines 5 and the plurality of signal lines 6, each are one (1) pixel 8.

For example, TFTs 9 are provided, for the respective pixels 8, near respective intersections of the plurality of scanning lines 5 and the plurality of signal lines 6. The TFTs 9 each serves as a driving element (switching element).

Each of the TFTs 9 is a three-terminal transistor having three terminals, i.e., a scanning electrode, a signal electrode, and a drain electrode. Note that, since a configuration of such a TFT 9 is conventionally known, their detailed descriptions are omitted and they are not illustrated.

The scanning electrodes of the TFTs 9 are connected with a corresponding one of the plurality of scanning lines 5. The signal electrodes of the TFTs 9 are connected with a corresponding one of the plurality of signal lines 6. The drain electrodes of the respective TFTs 9 are electrically connected with the pixel electrodes 12 via respective drain lines. With the configuration, in each of the pixels 8, a corresponding one of the TFTs 9 is turned on when a corresponding one of the plurality of scanning lines 5 is selected. This causes a signal voltage, which is determined based on a display data signal supplied from the control circuit (not illustrated), to be applied by a signal line driving circuit (not illustrated) to the liquid crystal panel 2 via a corresponding one of the plurality of signal lines 6. The liquid crystal panel 2 ideally holds a voltage, which has been applied at a time point when the corresponding one of the TFTs 9 is turned off, while the corresponding one of the TFTs 9 is being turned off because the selection of the corresponding one of the plurality of scanning lines 5 is ended.

A plurality of auxiliary capacitor lines 7 are provided in a layer, in which the plurality of scanning lines 5 are provided, so as to extend substantially in parallel with the plurality of scanning lines 5 and such that each of the plurality of auxiliary capacitor lines 7 comes across corresponding ones of the pixels 8.

Auxiliary capacitor electrodes (not illustrated) are provided, for the respective pixels 8, above the plurality of auxiliary capacitor lines 7 via a gate insulating film (not illustrated). Note that the auxiliary capacitor electrodes extend from the respective drain lines.

An interlayer insulating film (not illustrated) is provided over the auxiliary capacitor electrodes, the drain lines, the drain electrodes, the source electrodes, and the plurality of signal lines 6. The pixel electrodes 12 are provided on the interlayer insulating film.

Specifically, a first metal line layer (gate metal layer), a gate insulating film, a semiconductor layer, a second metal line layer (source metal layer), a protective film (passivation film) covering the TFTs 9 and the second metal line layer, the interlayer insulating film, the pixel electrodes 12, the vertical alignment film 13, and the polymer layer 14 are stacked on the insulating substrate 11 in this order.

The first metal line layer includes members such as the plurality of scanning lines 5, the scanning electrodes, and the plurality of auxiliary capacitor lines 7. The second metal line layer includes members such as the plurality of signal lines 6, the signal electrodes, the drain electrodes, the drain lines, and the auxiliary capacitor electrodes.

The auxiliary capacitor electrodes are electrically connected with the pixel electrodes 12 via respective contact holes (not illustrated) provided in the interlayer insulating film. This causes each of the auxiliary capacitor electrodes and a corresponding one of the plurality of auxiliary capacitor lines 7 to serve as a pair of electrodes of an auxiliary capacitor formed in a corresponding one of the pixels 8.

Note that, according to the present embodiment, an auxiliary capacitor formed between the auxiliary capacitor line 7 and the auxiliary capacitor electrode allows a pixel potential to be stabilized. Note, however, that the plurality of auxiliary capacitor lines 7 and the auxiliary capacitor electrodes can be provided as needed. The plurality of auxiliary capacitor lines 7 and the auxiliary capacitor electrodes can be formed as needed, and are not essential members.

The counter substrate 20 is, for example, a color filter substrate in which a color filter layer (not illustrated) of, for example, R (red), G (green), and B (blue) is provided between the insulating substrate 21 and the common electrode 22. Note that the color filter layer is provided for each of the pixel electrodes 12 of the active matrix substrate 10. Note, however, that the present embodiment is not limited to this. Alternatively, a COA (Color Filter On Array) configuration can therefore be employed in which a color filter layer is provided on a side of the active matrix substrate 10.

The following description will discuss an example configuration of the present embodiment in which a pixel 8 is divided into subpixels 8a and 8b along a signal line 6 (see (a) of FIG. 1), as with the configuration illustrated in FIG. 13. Note, however, that the present embodiment is not limited to this.

The pixel 8 is divided, by an auxiliary capacitor line 7 extending in parallel with a scanning line 5, into an upper half of the pixel 8 and a lower half of the pixel 8, i.e., subpixels 8a and 8b.

In the liquid crystal display device illustrated in (a) of FIG. 1, a pixel electrode 12 of the pixel 8 is divided into subpixel electrodes 12a and 12b (electrode unit) along the signal line 6.

The subpixel electrodes 12a and 12b of the respective subpixels 8a and 8b are electrically connected with each other, via a plurality of connection electrodes 15 (connecting parts) which are made from an electrode material identical with those of the subpixel electrodes 12a and 12b.

The liquid crystal panel 2 is a so-called MVA mode liquid crystal panel having a plurality of domains. In the liquid crystal panel 2, a fish-bone type pixel electrode having a fish-bone configuration is employed as each of the subpixel electrodes 12a and 12b. In each of the subpixels 8a and 8b, minute slits 16 are provided as alignment controlling means (domain controlling means) for controlling azimuths in which the liquid crystal molecules 31 are tilted while an electric field is being applied. The slits 16 are prepared by making cut-in parts as respective spaces (in which no pixel electrode is formed) from circumferential edges 52 and 53 so as to form a fish-bone shape.

Each of the subpixel electrodes 12a and 12b has linear electrodes (electrode lines), i.e., (i) a trunk line part 17 (trunk electrode) which has a cross shape and (ii) a plurality of branch line parts 18 (branch electrodes) extending from the trunk line part 17.

The trunk line part 17 is made up of (i) a first trunk line part 17a (first trunk electrode) extending in parallel with the signal line 6 and (ii) a second trunk line part 17b (second trunk electrode) extending in parallel with the scanning line 5.

The first trunk line part 17a of each of the subpixel electrodes 12a and 12b is provided so as to (i) pass through a center of the pixel electrode 12 and (ii) extend in parallel with the signal line 6. The second trunk line parts 17b extend in parallel with the scanning line 5 so as to pass through centers of the respective subpixel electrodes 12a and 12b. As such, the first trunk line part 17a and the second trunk line part 17b intersect with each other in the center of the each of the subpixel electrodes 12a and 12b.

The branch line parts 18 obliquely extend, at an angle of 45 degrees, from the first trunk line part 17a or the second trunk line part 17b in a stripe manner.

Specifically, in a case where (i) a rightward azimuth in (a) of FIG. 1 is defined as 0 degree and (ii) azimuth angles are measured in a counterclockwise direction, the branch line parts 18 and the slits 16 are provided so as to extend in an azimuth angle of 45 degrees, 135 degrees, 225 degrees, or 315 degrees.

This causes each of the subpixels 8a and 8b to be divided into four areas (domains) by a corresponding first trunk line part 17a and a corresponding second trunk line part 17b. To put it another way, the four domains (orientation areas R1 through R4), which are different in direction in which their liquid crystal molecules 31 are oriented, are provided in a matrix arrangement of 2 columns×2 rows in each of the subpixels 8a and 8b.

Specifically, in a case where (i) a rightward azimuth is defined as 0 degree and (ii) azimuth angles are measured in a counterclockwise direction, (i) branch line parts 18 and slits 16 in the orientation area R1 extend at an azimuth angle of 45 degrees with respect to the second trunk line part 17b, (ii) branch line parts 18 and slits 16 in the orientation area R2 extend at an azimuth angle of 135 degrees with respect to the second trunk line part 17b, (iii) branch line parts 18 and slits 16 in the orientation area R3 extend at an azimuth angle of 225 degrees with respect to the second trunk line part 17b, and (iv) branch line parts 18 and slits 16 in the orientation area R4 extend at an azimuth angle of 315 degrees with respect to the second trunk line part 17b.

In each of the orientation areas R1 through R4, the branch line parts 18 are thus provided in parallel with each other so as to be at an angle of 45 degrees with the first trunk line part 17a and the second trunk line part 17b. As such, the branch line parts 18 in one of any adjacent orientation areas extend in a direction substantially perpendicular to the branch line parts 18 in the other of any adjacent orientation areas. Note that the branch line parts 18 provided in the orientation areas R1 through R4 are connected with each other via the first trunk line part 17a and the second trunk line part 17b.

In each of the orientation areas R1 through R4, two to four branch line parts 18 are connected with each of the first trunk line part 17a and the second trunk line part 17b, depending on (i) a size of each of the subpixels 8a and 8b, (ii) a width of each of the branch line parts 18 each serving as an electrode line, and (iii) a width of each of the slits 16 each serving as a space.

In the example illustrated in (a) of FIG. 1, three branch line parts 18 are connected with each of the first trunk line part 17a and the second trunk line part 17b, that is, a total of six branch line parts 18 are provided in each of the orientation areas R1 through R4.

According to the present embodiment, (i) the branch line parts 18 are provided at fixed intervals and have identical widths and (ii) the slits 16 are provided at fixed intervals and have identical widths. Note, however, that the present embodiment is not limited to these.

It is preferable that a width w (connection width (line width), w1, w2) of each of the connection electrodes 15, in particular, a width w1 of a connection electrode 15, via which branch line parts 18 of the respective subpixel electrodes 12a and 12b are connected with each other, is set to be not wider than 6 μm. It is preferable that a length q (connection length (line length)) of each of the connection electrodes 15 is set to be not longer than 7.5 μm.

Note that, in a case where a conventional fine slit pattern is employed, as the pixel electrode pattern, in which trunk line parts 17 of respective subpixel electrodes 12a and 12b are connected with each other via a single connection electrode 15 so that subpixels 8a and 8b are connected with each other, a defective pixel is caused if the connection electrode 15 is electrically disconnected. This is because a voltage is not conveyed from one subpixel to another subpixel, e.g., from the subpixel 8a to the subpixel 8b, which causes no voltage to be applied to the subpixel 8b.

On the other hand, according to the present embodiment, the subpixels 8a and 8b are connected with each other via a plurality of connection electrodes 15. With the configuration, if an electrical disconnection is caused in one of the plurality of connection electrodes 15, a defective pixel can be prevented because the subpixels 8a and 8b are electrically connected with each other via the other(s) of the plurality of connection electrodes 15.

It is preferable that the connection electrodes 15 are provided away from a circumferential edge 51 (i.e., a circumferential part of an area defined by connecting ends of branch line parts 18 and ends of the trunk line parts 17, which ends face the scanning lines 5 and the signal lines 6 which compartmentalize the pixel 8) of the entire pixel electrode 12.

Specifically, it is preferable that the subpixel electrodes 12a and 12b, which are adjacent to each other, are connected with each other via the connection electrodes 15 which are provided in regions other than the circumferential edge 51 of the pixel electrode 12 (i.e., in inner regions of the circumferential edge 51).

More specifically, it is preferable that some of ends of electrode lines, which (i) constitute the respective circumferential edges 52 and 53 of the respective subpixel electrodes 12a and 12b but (ii) do not constitute the circumferential edge 51 of the pixel electrode 12, are connected with each other via respective connection electrodes 15. That is, it is preferable that (a) some first ends of first electrode lines of the subpixel electrode 12a and (b) respective second ends of second electrode lines of the subpixel electrode 12b are connected with each other, via respective connection electrodes 15. Note that the first electrode lines face the respective second electrode lines, via a boundary between the subpixel electrodes 12a and 12b but do not constitute the circumferential edge 51 of the entire pixel electrode 12.

In this case, it is preferable that the trunk line parts 17 are included in electrode lines which are connected with each other via connection electrodes 15. With the configuration, it is possible to easily reduce a resistance generated when the adjacent subpixel electrodes 12a and 12b are connected with each other. As such, it is possible to stably apply a voltage to the subpixel electrodes 12a and 12b.

In other words, it is preferable that (i) the first trunk line parts 17a of the respective subpixel electrodes 12a and 12b are connected with each other via a connection electrode 15 and (ii) some of first branch line parts 18 of the subpixel electrode 12a and respective second branch line parts 18 of the subpixel electrode 12b, which first and second branch line parts 18 do not constitute the circumferential edge 51 of the entire pixel electrode 12, are connected with each other via respective connection electrodes 15.

In this case, it is preferable that a distance d between the circumferential edge 51 and an edge 15a of a connection electrode 15, which edge 15a is closest to the circumferential edge 51, is not shorter than 1 μm.

Note that an upper limit of the distance d is of course determined in accordance with a width of the pixel electrode 12 in a direction perpendicular to a direction in which the subpixels 8a and 8b are juxtaposed to each other, on the condition that a plurality of connection electrodes 15 are provided between right and left sides of the circumferential edge 51. Specifically, in a case of (a) of FIG. 1, the upper limit of the distance d is determined in accordance with a distance p between the right and left sides of the circumferential edge 51. In other words, in a case where the number of connection electrodes 15 and a width w of each of the plurality of connection electrodes 15 are determined, the upper limit of the distance d is determined from the distance p, accordingly.

According to the example illustrated in (a) of FIG. 1, (i) the first trunk line parts 17a of the respective subpixel electrodes 12a and 12b are connected with each other via a connection electrode 15 and (ii) (a) branch line parts 18 of the subpixel electrodes 12a and 12b, which branch line parts 18 are second ones from the right side of the circumferential edge 51 are connected with each other via a connection electrode 15 and (b) branch line parts 18 of the subpixel electrodes 12a and 12b, which branch line parts 18 are second ones from the left side of the circumferential edge 51 are connected with each other via a connection electrode 15. Note, however, that the present embodiment is not limited to this.

As above described, connecting parts of electrode lines of the respective subpixel electrodes 12a and 12b which connecting parts are connected to each other via a connection electrode 15 can be ends of respective electrode lines which ends do not constitute the circumferential edge 51 of the pixel electrode 12. Therefore, the electrode lines connected with each other via the connection electrode 15 are not limited to those illustrated in (a) of FIG. 1, that is, not limited to (i) the branch line parts 18 of the subpixel electrodes 12a and 12b, which branch line parts 18 are second ones from both right and left sides of the circumferential edge 51 and (ii) the first trunk line parts 17a of the respective subpixel electrodes 12a and 12b.

The number of locations in which the subpixel electrodes 12a and 12b are connected with each other, that is, the number of the plurality of connection electrodes 15 are not limited to a particular one, provided that the number is two or more. It is therefore possible that all first electrode lines of the subpixel electrode 12a, which first electrode lines do not constitute the circumferential edge 51, can be connected with respective all second electrode lines of the subpixel electrode 12b, which second electrode lines face the respective first electrode lines and have ends not constituting the circumferential edge 51.

According to the example illustrated in (a) of FIG. 1, (i) the pixel 8 has a side which extends in parallel with the signal line 6 and is longer than a side extending in parallel with the scanning line 5 and (ii) the subpixels 8a and 8b are juxtaposed to each other along the signal line 6. According to the example configuration illustrated in (a) of FIG. 1, ends of the trunk line parts 17 of the respective subpixel electrodes 12a and 12b, which ends do not constitute the circumferential edge 51, are therefore ends of the first trunk line parts 17a of the respective subpixel electrodes 12a and 12b which ends are connected with each other via a connection electrode 15.

Alternatively, in a case where, for example, (i) the pixel 8 has a side which extends in parallel with the scanning line 5 and is longer than the side extending in parallel with the signal line 6 and (ii) the subpixels 8a and 8b are juxtaposed to each other along the scanning line 5, ends of the trunk line parts 17 of the respective subpixel electrodes 12a and 12b, which ends do not constitute the circumferential edge 51, are one ends of the respective second trunk line parts 17b extending in parallel with the scanning line 5. In this case, the one ends of the second trunk line parts 17b of the respective subpixel electrodes 12a and 12b are of course connected with each other via a connection electrode 15.

In the example illustrated in (a) of FIG. 1, first ends of electrode lines of the subpixel electrode 12a are linearly connected with respective second ends of electrode lines of the subpixel electrode 12b, which second ends face the respective first ends. Note, however, that the present embodiment is not limited to this. It is therefore possible that electrode lines of the respective subpixel electrodes 12a and 12b can be connected with each other so as to be extensions of the respective electrode lines, provided that a connection point of the electrode lines is away from the circumferential edge 51 (i.e., more inner side than of the circumferential edge 51), as with the configuration early described.

Specifically, branch line parts 18, facing each other, of the respective subpixel electrodes 12a and 12b can be connected with each other so as to be an extension of the branch line parts 18, via a V-shaped connecting part.

According to the present embodiment, electrode lines of the respective subpixel electrodes 12a and 12b are connected with each other in an optimum location (i.e., via an optimum connection electrode 15) so that slits 16 of the respective subpixel electrodes 12a and 12b are connected with each other in an optimum location. This allows a disorder of orientation of liquid crystal molecules to be suppressed.

The following description will discuss results of simulations carried out for verifying optimal connection locations of electrode lines of the subpixel electrodes 12a and 12b, in view of a relation between (i) a connection location of electrode lines and (ii) a disorder of orientation of liquid crystal molecules.

[Relation Between (i) Connection Location of Electrode Lines and (ii) Disorder of Orientation of Liquid Crystal Molecules]

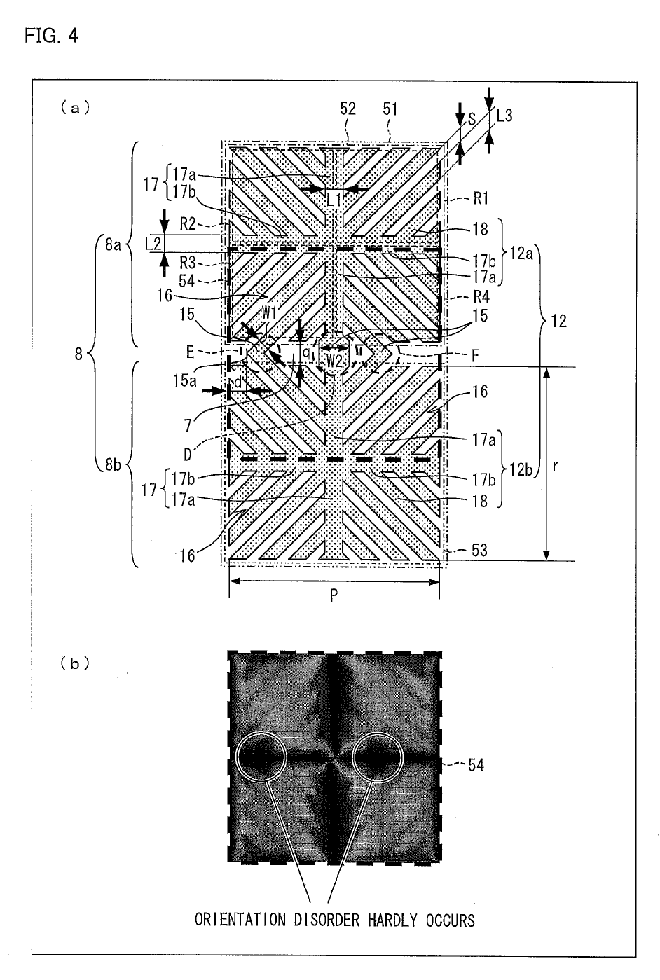

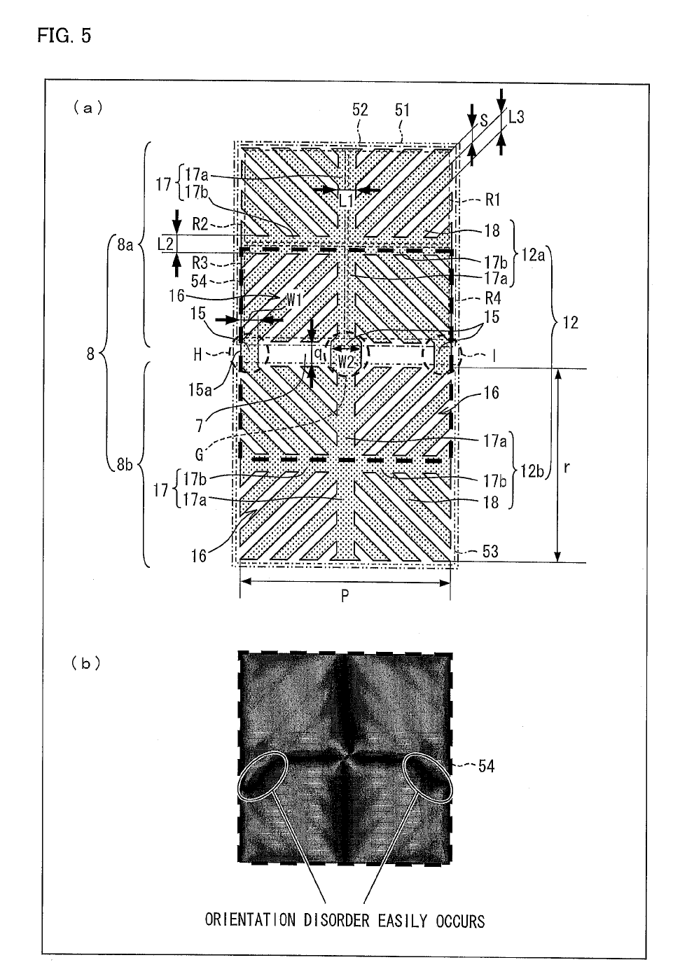

Each of (a) of FIG. 4 and (a) of FIG. 5 illustrates an example layout of a pixel electrode pattern of a pixel 8.

According to the example illustrated in (a) of FIG. 1, the subpixel electrodes 12a and 12b were linearly connected with each other in a total of three locations. That is, the subpixel electrodes 12a and 12b were connected with each other via (i) ends of the first trunk line parts 17a of the respective subpixel electrodes 12a and 12b (see a dotted area A in (a) of FIG. 1), (ii) ends of branch line parts 18 of the respective subpixel electrodes 12a and 12b, which branch line parts 18 were respective second ones from the left side of the circumferential edge 51 (see a dotted area B in (a) of FIG. 1), and (iii) ends of branch line parts 18 of the respective subpixel electrodes 12a and 12b, which branch line parts 18 were respective second ones from the right side of the circumferential edge 51 (see a dotted area C in (a) of FIG. 1).

On the other hand, in an example illustrated in (a) of FIG. 4, ends of first trunk line parts 17a of respective subpixel electrodes 12a and 12b were linearly connected with each other (see a dotted area D in (a) of FIG. 4). Further, (i) ends of branch line parts 18 of the respective subpixel electrodes 12a and 12b, which branch line parts 18 were respective second ones from a left side of a circumferential edge 51, were connected with each other so as to form a V-shape (see a dotted area E in (a) of FIG. 4) and (ii) ends of branch line parts 18 of the respective subpixel electrodes 12a and 12b, which branch line parts 18 were respective third ones from a right side of the circumferential edge 51, were connected with each other so as to form a V-shape (i.e., a dotted area F in (a) of FIG. 4). Even in the example illustrated in (a) of FIG. 4, the subpixel electrodes 12a and 12b were connected with each other in a total of three locations.

In an example illustrated in (a) of FIG. 5, the subpixel electrodes 12a and 12b were linearly connected with each other in a total of three locations. That is, the subpixel electrodes 12a and 12b were connected with each other via (i) ends of the first trunk line parts 17a of the respective subpixel electrodes 12a and 12b (see a dotted area G in (a) of FIG. 5), (ii) ends of branch line parts 18 of the respective subpixel electrodes 12a and 12b, which ends were adjacent to the left side of the circumferential edge 51 (see a dotted area H in (a) of FIG. 5) and (iii) ends of branch line parts 18 of the respective subpixel electrodes 12a and 12b, which ends were adjacent to the right side of the circumferential edge 51 (see a dotted area I in (a) of FIG. 5).

The examples illustrated in respective (a) of FIG. 1, (a) of FIG. 4, and (a) of FIG. 5 employed identical conditions, except that the connection locations of the subpixel electrodes 12a and 12b and the shapes of the connecting parts are changed, as above described. Note that, in the example of (a) of FIG. 5, a distance d was set to 0 μm between (i) respective edges 15a of connection electrodes 15, each of which connects corresponding branch line parts 18 with each other, and (ii) respective right and left sides of the circumferential edge 51.

(b) of FIG. 1, (b) of FIG. 4, and (b) of FIG. 5 are views each illustrating orientations of liquid crystal molecules, which were obtained by carrying out orientation simulations with respect to the pixel electrode patterns illustrated in respective of (a) of FIG. 1, (a) of FIG. 4, and (a) of FIG. 5.

Each of (b) of FIG. 1, (b) of FIG. 4, and (b) of FIG. 5 illustrates orientations of the liquid crystal molecules 31 in a dotted area 54 in a corresponding one of (a) of FIG. 1, (a) of FIG. 4, and (a) of FIG. 5. Note that each of the areas 54 was an area between the first trunk line parts 17a of the respective subpixel electrodes 12a and 12b. Also note that the orientations of the liquid crystal molecules 31, illustrated in each of (b) of FIG. 1, (b) of FIG. 4, and (b) of FIG. 5, were obtained while an electric potential of 7V was being applied to the pixel electrode 12 and an electric potential of 0V was being applied to the common electrode 22.

Note that, in the orientation simulations, “Expert LCD” (product name) manufactured by Daou Xilicon Technology Co., LTD. was used.

In the case where the subpixel electrodes 12a and 12b were connected with each other in a manner illustrated in (a) of FIG. 1, (b) of FIG. 1 demonstrates that there occurs no disorder of orientation of liquid crystal molecules 31 (hereinafter, referred to merely as “orientation disorder”). It is therefore clear that an orientation disorder was difficult to occur in the configuration illustrated in (a) of FIG. 1. Note that dotted areas in (b) of FIG. 1 correspond to the areas B and C (connection locations).

In a case where the subpixel electrodes 12a and 12b were connected with each other in a manner illustrated in (a) of FIG. 4, an orientation pattern of the liquid crystal molecules 31 was obtained, which pattern was similar to that of (b) of FIG. 1, and an orientation disorder was not caused (see (b) of FIG. 4). This demonstrates that an orientation disorder was difficult to occur in the configuration illustrated in (a) of FIG. 4. Note that dotted areas in (b) of FIG. 4 correspond to the areas E and F (connection locations).

On the other hand, in a case where the subpixel electrodes 12a and 12b were connected with each other in a manner illustrated in (a) of FIG. 5, orientation disorders were caused in dotted areas H and I (connection locations) (see (b) of FIG. 5). This demonstrates that, in a case where branch line parts 18 of the respective subpixel electrodes 12a and 12b, which abutted on right and left sides of the circumferential edge 51, were connected with each other, (i) it was possible to suppress a defective pixel caused by an electrical disconnection but (ii) an orientation disorder was easily caused, so as to adversely affect an optical characteristic.

The following description will discuss reasons of the above (ii), together with an orientation principle of the liquid crystal molecules 31 in the liquid crystal panel 2.

[Orientation Principle of Liquid Crystal Molecules]

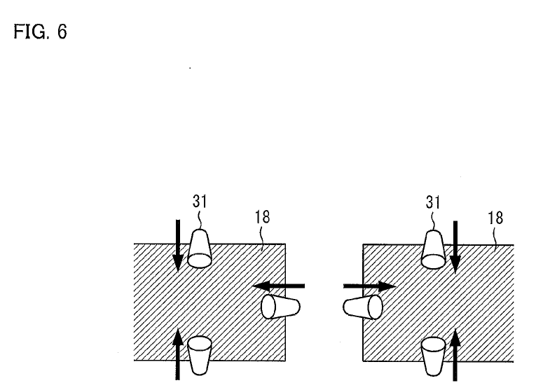

The following description will discuss the orientation principle of the liquid crystal molecules 31 in the liquid crystal panel 2, with reference to FIGS. 6 through 8.

FIG. 6 is a plane view schematically illustrating what orientation characteristic liquid crystal molecules 31 have in edge parts of branch line parts 18 while an electric field is being applied.

In an edge of an electrode, a liquid crystal molecule 31 is tilted toward a center of the electrode while an electric field is being applied. Under the circumstances, in a case where an electric field is applied to liquid crystal molecules 31 in each edge part of a branch line part 18 of each of the subpixel electrodes 12a and 12b, the liquid crystal molecules 31 are tilted toward a center of the branch line part 18 (see FIG. 6).

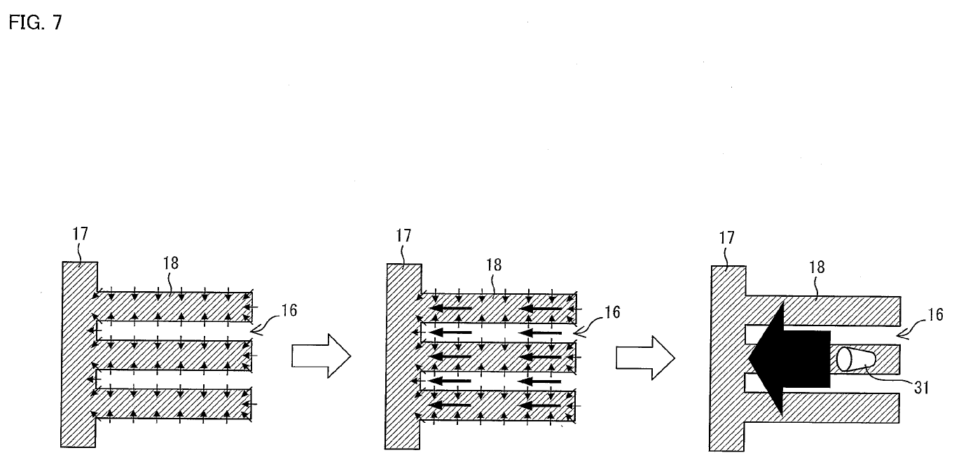

FIG. 7 is a plane view schematically illustrating what orientation characteristic liquid crystal molecules 31 have, while an electric field is being applied, in branch line parts 18 connected with a trunk line part 17.

Directions, in which liquid crystal molecules 31 are tilted while an electric field is being applied, are determined in accordance with oriented directions of liquid crystal molecules 31 in a middle part of an electrode (middle part of line) and in a middle part of a space between adjacent electrodes.

In edge parts of a trunk line part 17 of each of the subpixel electrodes 12a and 12b, liquid crystal molecules 31 are to be tilted toward a canter of each of branch line parts 18. As such, liquid crystal molecules 31, in a middle part of each of the branch line parts 18 and in a slit 16 (space) between respective adjacent branch line parts 18, are effected by orientations of liquid crystal molecules 31 in edge parts of the branch line parts 18, and are oriented so as to tilt toward the trunk line part 17 (see FIG. 7).

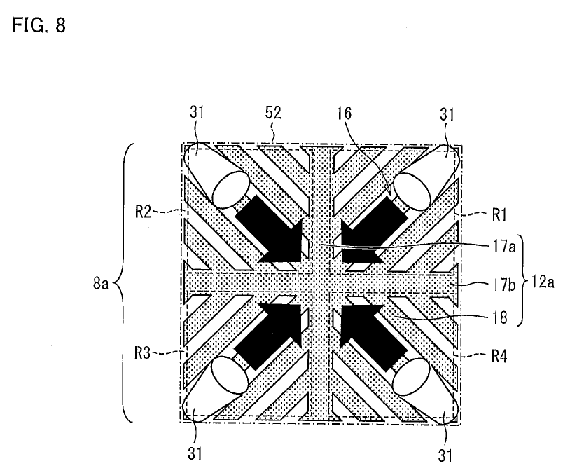

FIG. 8 is a plane view schematically illustrating an orientation characteristic of liquid crystal molecules 31 in a subpixel of the liquid crystal panel 2. Note that FIG. 8 illustrates, as an example, an orientation characteristic of liquid crystal molecules 31 in a subpixel 8a.

In a case where (i) a rightward azimuth (in which a first trunk line part 17a extends) in FIG. 8 is defined as 0 degree and (ii) azimuth angles are measured in a counterclockwise direction, branch line parts 18 and slits 16 are provided in a subpixel electrode 12a so as to extend in an azimuth angles of 45 degrees, 135 degrees, 225 degrees, or 315 degrees.

According to the subpixel 8a corresponding to the subpixel electrode 12a having such a shape, in a case where an electric field is applied to liquid crystal molecules 31 in the subpixel 8a, the liquid crystal molecules 31 are tilted toward a center of the subpixel 8a, i.e., toward an intersection of the first trunk line part 17a and a second trunk line part 17b of the subpixel electrode 12a.

From the facts, it is believed that the orientation disorders are caused in the connecting parts abutting on the circumferential edge 51 of the pixel electrode 12 because of reasons described below. That is, orientation disorders of liquid crystal molecules 31 seem to be caused based on the following mechanism.

[Reason why Orientation Disorder is Caused in Connecting Parts on Circumferential Edge of Pixel Electrode]

(a) of FIG. 9 is a plane view illustrating a layout of a pixel electrode pattern, in a pixel 8, obtained in a case where (i) branch line parts 18 of a subpixel electrode 12a, which are second ones from respective right and left sides of a circumferential edge 51 of a pixels electrode 12, are connected with (ii) respective branch line parts 18 of a subpixel electrode 12b, which are also second ones from the respective right and left sides of the circumferential edge 51, as with the configuration illustrated in (a) of FIG. 1. (b) of FIG. 9 is a plane view illustrating a layout of a pixel electrode pattern in a pixel 8 in which (i) branch line parts 18 of respective subpixel electrodes 12a and 12b, which abut on right and left sides of a circumferential edge 51 of a pixel electrode 12, are connected with each other, as with the configuration illustrated in (a) of FIG. 5.

In (a) and (b) of FIG. 9, arrows in dotted areas indicate respective forces applied to liquid crystal molecules 31 in the vicinity of a boundary between the subpixels 8a and 8b on the circumferential edge 51.

In a case where the subpixels 8a and 8b are connected with each other by connecting branch line parts 18 of the subpixel electrode 12a with respective branch line parts 18 of the subpixel electrode 12b on the right and left sides of the circumferential edge 51 (see (b) of FIG. 9), no force is exerted in a dotted area which force causes liquid crystal molecules 31 to tilt in oblique directions (i.e., in directions toward centers of the respective subpixels 8a and 8b). This causes orientations of liquid crystal molecules 31 to be unstable in the area of edge parts of branch line parts 18 on the right and left sides of the circumferential edge 51.

On the other hand, in a case where the subpixels 8a and 8b are connected with each other by connecting branch line parts 18 of the respective subpixel electrodes 12a and 12b with each other in locations more inner side than and away from the circumferential edge 51 (see (a) of FIG. 9), forces are exerted which forces cause liquid crystal molecules 31 to tilt in oblique directions (i.e., in directions toward centers of the respective subpixels 8a and 8b) in edge parts of branch line parts 18 in the vicinity of the boundary between the subpixels 8a and 8b on the circumferential edge 51 (see dotted area in (a) of FIG. 9). This causes orientations of the liquid crystal molecules 31 to be stable in the edge parts.

[Relation Between (i) L and S and (ii) Orientation of Liquid Crystal Molecule]

The following description will discuss results of simulations carried out to check a relation between (i) (a) a width L (line width) of an electrode line and (b) a width S (space width) a slit 16 in each of the subpixel electrodes 12a and 12b and (ii) orientations of liquid crystal molecules 31 in each of the subpixel electrodes 12a and 12b.

(a) of FIG. 10 is a plane view illustrating an example layout of a pixel electrode pattern obtained in a case where a width L and a width S in the subpixel 8a are identical with those in the subpixel 8b. (b) of FIG. 10 illustrates an orientated state of liquid crystal molecules obtained by carrying out an orientation simulation with respect to the pixel electrode pattern illustrated in (a) of FIG. 10.

Each of (a) of FIG. 11 and (a) of FIG. 12 is a plane view illustrating an example layout of a pixel electrode pattern obtained in a case where a width L and a width S in the subpixel 8a are different from those in the subpixel 8b. Each of (b) of FIG. 11 and (b) of FIG. 12 illustrates an oriented state of liquid crystal molecules obtained by carrying out an orientation simulation with respect to the pixel electrode pattern illustrated in a corresponding one of (a) of FIG. 11 and (a) of FIG. 12.

Hereinafter, a width (line width) of a first trunk line part 17a is referred to as “L1”, a width (line width) of a second trunk line part 17b is referred to as “L2”, and a width (line width) of a branch line part 18 is referred to as “L3”, as is shown in (a) of FIG. 1, etc.

In the example illustrated in (a) and (b) of FIG. 10, a width L was set to 2.5 μm (L1=L2=L3) and a width S was set to 2.5 μm in each of the subpixels 8a and 8b.

In the example illustrated in (a) and (b) of FIG. 11, a width L was set to 2.5 μm (L1=L2=L3) and a width S was set to 2.5 μm in the subpixel 8a, and a width L was set to 3 μm (L1=L2=L3) and a width S was set to 3 μm in the subpixel 8b.

In the example illustrated in (a) and (b) of FIG. 12, a width L was set to 2.5 μm (L1=L2=L3) and a width S was set to 2.5 μm in the subpixel 8a, and a width L was set to 3.5 μm (L1=L2=L3) and a width S was set to 3.5 μm in the subpixel 8b.

As a result of the simulations, it was possible to confirm that no significant orientation disorder was caused even in the cases where the width L and the width S in the subpixel 8a are different from those in the subpixel 8b (see (a) and (b) of FIG. 11 and (a) and (b) of FIG. 12), as with the case where the width L and the width S in the subpixel 8a are identical with those in the subpixel 8b (see (a) and (b) of FIG. 10). This is because, in each of the configurations of (a) of FIG. 11 and (a) of FIG. 12, branch line parts 18 of the subpixel electrode 12a were connected with respective branch line parts 18 of the subpixel electrode 12b in locations more inner side than and away from the circumferential edge 51.

As above described, according to the present embodiment, electrode lines of the subpixel electrode 12a are connected with respective electrode lines of the subpixel electrode 12b in locations more inner side than and away from the circumferential edge 51 of the pixel electrode 12. With the configuration, it is possible to suppress an orientation disorder, regardless of a width L and a width S.

The present embodiment thus described employs the example configuration in which each of the subpixels 8a and 8b has the four orientation areas (i.e., orientation areas R1 through R4). Note, however, that the present embodiment is not limited to this. Subpixels 8a and 8b can be provided so as to have, for example, two orientation areas which are separated from each other by a first trunk line part 17a extending in parallel with a direction in which the subpixels 8a and 8b are juxtaposed to each other. Note, however, that, in the case where each of the subpixels 8a and 8b is provided so as to have the orientation areas R1 through R4 (i.e., four orientation areas), it is possible to provide a liquid crystal panel 2 having less viewing angle dependency.

The present embodiment thus described employs the example configuration in which the branch line parts 18 extend, at an angle of 45 degrees, from the first trunk line part 17a or the second trunk line part 17b in a stripe manner. Specifically, in a case where (i) a rightward azimuth in, for example, (a) of FIG. 1 is defined as 0 degree and (ii) azimuth angles are measured in a counterclockwise direction, the branch line parts 18 and the slits 16 are provided so as to extend in an azimuth angle of 45 degrees, 135 degrees, 225 degrees, or 315 degrees. Note, however, that the present embodiment is not limited to this, and that the branch line parts 18 can therefore extend from the first trunk line part 17a or the second trunk line part 17b at an angle other than 45 degrees.

In each of the pixels 12, branch line parts 18 of a subpixel 12a can extend from a first trunk line part 17a or a second trunk line part 17b at an angle different from that in an adjacent subpixel 12b.

This makes it possible to change a viewing angle.

An angle between a branch line part 18 and a first trunk line part 17a or a second trunk line part 17b can be set to fall within a range between, for example, 40 degrees and 60 degrees.

It is possible to obtain a viewing angle which is wide in a horizontal direction, in a case where, for example, each of pixels is made up of (i) a first subpixel in which an angle between a branch line part 18 and a first trunk line part 17a or a second trunk line part 17b is smaller than 45 degrees (e.g., 40 degrees) and (ii) a second subpixel in which an angle between a branch line part 18 and a first trunk line part 17a or a second trunk line part 17b is equal to or larger than 45 degrees (e.g., 45 degrees).

Alternatively, it is possible to obtain a viewing angle which is wide in a vertical direction, in a case where each of pixels is made up of (i) a first subpixel in which an angle between a branch line part 18 and a first trunk line part 17a or a second trunk line part 17b is larger than 45 degrees (e.g., 60 degrees) and (ii) a second subpixel in which an angle between a branch line part 18 and a first trunk line part 17a or a second trunk line part 17b is equal to or smaller than 45 degrees (e.g., 45 degrees).

The present embodiment has thus described the example in which the configuration is employed in which each of the subpixel electrodes 12a and 12b has the fish-bone structure. Note, however, that the present embodiment is not limited to this. Therefore, an electrode pattern of the pixel electrode 12 is not limited to a particular one, provided that (i) each of the subpixel electrodes 12a and 12b is made up of linear electrodes (electrode lines) defined (demarcated) by fine slits (in other words, each of the subpixel electrodes 12a and 12b is made up of fine slit sections and electrode line sections (linear electrodes)) and (ii) the subpixel electrodes 12a and 12b are connected with each other in a plurality of locations, i.e., via a plurality of connection electrodes 15 (preferably, in locations more inner side than and away from the circumferential edge 51 of the pixel electrode 12).

The present embodiment thus described employs the example configuration in which a pixel 8 has two subpixels, i.e., subpixels 8a and 8b, and an electrode 12 has two subpixel electrodes, i.e., subpixel electrodes 12a and 12b. Note, however, that the present embodiment is not limited to this. It is therefore possible to provide three or more subpixels in one (1) pixel, provided that the one (1) pixel has two or more subpixels.

As above described, a liquid crystal panel of the present embodiment includes: a first substrate on which pixel electrodes are provided for respective pixels; a second substrate on which a common electrode is provided, the second substrate being provided so as to face the first substrate; a liquid crystal layer provided between the first substrate and the second substrate, the liquid crystal layer having a negative dielectric anisotropy; and a pair of vertical alignment films provided over respective of the first substrate and the second substrate, each of the pixels being divided into a plurality of subpixels, each of the pixel electrodes having (i) a plurality of subpixel electrodes and (ii) a plurality of connection electrodes via which adjacent two of the plurality of subpixel electrodes are connected with each other, each of the plurality of subpixels having a plurality of linear electrodes demarcated by a plurality of slits, in each of the pixels, any adjacent first and second subpixel electrodes of the plurality of subpixel electrodes, being connected with each other in a plurality of locations by connecting some of first linear electrodes of the first subpixel electrode with respective second linear electrodes of the second subpixel electrode via respective connection electrodes.

According to the present embodiment, it is therefore possible to provide the liquid crystal panel which can suppress (i) occurrence of a defective pixel and (ii) a decrease in display quality.

In this case, it is preferable that the plurality of linear electrodes includes (i) a trunk electrode extending in parallel with a direction in which the first subpixel electrode and the second subpixel electrode are juxtaposed to each other and (ii) branch electrodes extending, in an oblique direction, from the trunk electrode in a stripe manner; and in each of the pixels, the plurality of locations, in which the first subpixel electrode and the second subpixel electrode are connected with each other, are located more inner side than and away from a circumferential edge of a corresponding one of the pixel electrodes, the circumferential edge being defined by a line connecting ends of linear electrodes of the corresponding one of the pixel electrodes with each other.

As early described, in a case where the linear electrode has (i) the trunk electrode extending in parallel with the direction in which the subpixels are juxtaposed to each other and (ii) the branch electrodes extending, in an oblique direction, from the trunk electrode in a stripe manner, forces are exerted in each pixel which forces cause liquid crystal molecules to tilt in oblique directions. However, in a case where the linear electrodes are connected with each other in each locations abutting on the circumferential edge of the pixel, such forces to tilt the liquid crystal molecules in oblique directions are not exerted in edge parts of branch electrodes which edge parts abut on the circumferential edge of the pixel electrode.

On the other hand, as above described, in a case where linear electrodes of a subpixel electrode are connected with respective linear electrodes of an adjacent subpixel electrode in respective locations more inner side than and away from the circumferential edge of the pixel electrode, forces are exerted which forces cause the liquid crystal molecules to tilt in oblique directions in edge parts of branch electrodes which edge parts abut on the circumferential edge of the pixel electrode. This allows orientations of liquid crystal to be stabled in the edge parts.

According to the configuration, it is therefore possible to provide the liquid crystal panel which can (i) suppress occurrence of not only a defective pixel but also an orientation disorder and (ii) achieve high display quality.

In this case, it is preferable that the first linear electrodes and the second linear electrodes have respective ends which do not constitute the circumferential edge.

With the configuration, it is possible to easily and certainly connect linear electrodes of a subpixel electrode with respective linear electrodes of an adjacent subpixel electrode in respective locations more inner side than and away from the circumferential edge of the pixel electrode.

According to the configuration, it is therefore possible to easily and certainly provide the liquid crystal panel which can (i) suppress occurrence of not only a defective pixel but also an orientation disorder and (ii) achieve high display quality.

It is possible that, in each of the pixels, an angle between a trunk electrode and a branch line part in one of adjacent subpixels is different from that in the other of the adjacent subpixels.

This makes it possible to change a viewing angle.

The liquid crystal display device of the present embodiment includes the liquid crystal panel of the present embodiment. Therefore, the liquid crystal display device of the present embodiment can suppress (i) occurrence of a defective pixel and (ii) a decrease in display quality.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The liquid crystal panel and the liquid crystal display device of the present invention can suppress (i) a defective pixel and (ii) a reduction in display quality. The present invention is therefore suitable for use in a device such as a liquid crystal television which is demanded to have high display quality.

### REFERENCE SIGNS LIST

1: Liquid crystal display device
2: Liquid crystal panel
3: Liquid crystal cell
4: Backlight
5: Scanning line
6: Signal line
7: Auxiliary capacitor line
8: Pixel
8a: Subpixel
8b: Subpixel
9: TFT
10: Active matrix substrate (first substrate)
11: Insulating substrate
12: Pixel electrode
12a: Subpixel electrode
12b: Subpixel electrode
13: Vertical alignment film
14: Polymer layer
15: Connection electrode
15a: Edge
16: Slit
17: Trunk line part (trunk electrode)
17a: First trunk line part (trunk electrode)
17b: Second trunk line part (trunk electrode)
18: Branch line part (branch electrode)
20: Counter substrate (second substrate)
21: Insulating substrate
22: Common electrode
30: Liquid crystal layer
31: Liquid crystal molecule
41: Lower quarter wave plate
42: Upper quarter wave plate
43: Lower polarization plate
44: Upper polarization plate
51: Circumferential edge (circumferential edge of pixel)
52: Circumferential edge (circumferential edge of subpixel)
53: Circumferential edge (circumferential edge of subpixel)

1. A liquid crystal panel comprising:
a first substrate on which pixel electrodes are provided for respective pixels;
a second substrate on which a common electrode is provided, the second substrate being provided so as to face the first substrate;
a liquid crystal layer provided between the first substrate and the second substrate, the liquid crystal layer having a negative dielectric anisotropy; and
a pair of vertical alignment films provided over respective of the first substrate and the second substrate,
each of the pixels being divided into a plurality of subpixels,
each of the pixel electrodes having (i) a plurality of subpixel electrodes and (ii) a plurality of connection electrodes via which adjacent two of the plurality of subpixel electrodes are connected with each other,
each of the plurality of subpixels having a plurality of linear electrodes demarcated by a plurality of slits,
in each of the pixels, any adjacent first and second subpixel electrodes of plurality of subpixel electrodes, being connected with each other in a plurality of locations by connecting some of first linear electrodes of the first subpixel electrode with respective second linear electrodes of the second subpixel electrode via respective connection electrodes.

2. The liquid crystal panel as set forth in claim 1, wherein:
the plurality of linear electrodes include (i) a trunk electrode extending in parallel with a direction in which the first subpixel electrode and the second subpixel electrode are juxtaposed to each other and (ii) branch electrodes extending, in an oblique direction, from the trunk electrode in a stripe manner; and
in each of the pixels, the plurality of locations, in which the first subpixel electrode and the second subpixel electrode are connected with each other, are located more inner side than and away from a circumferential edge of a corresponding one of the pixel electrodes, the circumferential edge being defined by a line connecting ends of linear electrodes of the corresponding one of the pixel electrodes with each other.

3. The liquid crystal panel as set forth in claim 2, wherein:
the first linear electrodes and the second linear electrodes have respective ends which do not constitute the circumferential edge.

4. The liquid crystal panel as set forth in claim 1, wherein:
in each of the pixels, an angle between a trunk electrode and each of the branch electrodes in one of adjacent subpixels is different from that in the other of the adjacent subpixels.

5. A liquid crystal display device comprising a liquid crystal panel recited in claim 1.
